(19) United States
(12) Patent Application Publication
(10) Pub. No.: US 2004/0005892 A1
(43) Pub. Date: Jan. 8, 2004

(54) System and method for managing parameter exchange between telecommunications operators

(76) Inventors: Arnaldo Mayer, Herzliya (IL); Irit Mayer Sterdiner, Herzliya (IL)

Correspondence Address: STAAS & HALSEY LLP, SUITE 700, 1201 NEW YORK AVENUE, N.W., WASHINGTON, DC, 20005, US

(21) Appl. No.: 10/418,314

(22) Filed: Apr. 18, 2003

Related U.S. Application Data
(60) Provisional application No. 60/373,379, filed on Apr. 18, 2002.

(51) Int. Cl. H04Q 7/20

(52) U.S. Cl. 455/432.1; 455/432.3; 455/453

(57) ABSTRACT

A system and method for synchronizing operating parameters among telephone network operators, and in particular mobile network operators. Each operator operates a mobile network according to values of operating parameters maintained by the operator. The apparatus may have a device provided with connectivity to the production operating parameters and values maintained by a first operator, where the device automatically detects a new operating parameter or value maintained by a first operator and in response uses a data network to automatically cause a second mobile operator to update its operating parameters or values to reflect the new or updated local parameter of the first operator.

### CROSS-REFERENCE TO RELATED APPLICATION

This application is related to and claims priority to U.S. provisional application entitled An Automation System For The Management Of Parameter Exchange Between Public Telecommunication Network Operators having Ser. No. 60/373,379, by Arnaldo Mayer, filed Apr. 18, 2002 and incorporated by reference herein.

### BACKGROUND OF THE INVENTION

1. Field of the Invention

The present invention is directed to the field of telephony. More particularly, the present invention is directed to the field of sharing roaming parameters among network operators. The roaming parameters may relate to roaming agreements between network operators.

2. Description of the Related Art

Mobile network or telephone network/switch operators (“operators”) often sign roaming the agreements with each other, by which they agree to service each other's roaming mobile customers. When a roaming agreement is signed by two operators, those operators exchange technical information or documents that detail their respective network information and identification parameters.

FIGS. 1-4 show an example of a technical document 10 exchanged between operators that have agreed to handle each other's roaming customers. The document 10 is an industry-standard IR21 document typically used, among other documents, in the case of Global System for Mobile (GSM) network operators. As shown in the example document 10, operators with roaming agreements typically need to exchange information related to: telephony routing 12; Signaling Connection Control Part (SCCP) gateways 14; GPRS (General Packet Radio Service) information 16; CAMEL (Customized Application for Mobile Network Enhanced Logic) information 18; Mobile Application Part (MAP) 20; miscellaneous information 22; and so forth. More particularly, exchanged parameters may include Mobile Subscriber Roaming Number (MSRN) ranges, a Destination Point Code (DPC), a Mobile Network Code (MNC), etc.

The information in these exchanged documents is generally stored as reference parameters in databases or equipment of the respective network operators. For example, the parameters may reside in or be used by the existing Mobile Switching Centers (MSCs) and Home Location Registers (HLRs) of the respective operators.

As discussed in the Detailed Description below, after two or more network operators have exchanged parameters and have begun to handle roaming calls for one another, if there are problems with the exchanged operating parameters and their values, roaming calls can fail. For example, if a routing parameter received from a partner changes at the partner's network, then calls for that partner may not be able to be handled or connected. What is needed is a system and method for efficiently and automatically detecting changes and maintaining synchronization of operating parameters mutually used by network operators that have roaming agreements or that switch or handle mobile calls.

### SUMMARY OF THE INVENTION

It is an aspect of the present invention to provide a system for automatically detecting changes in telephone network operating parameters that are relevant to other telephone network operators.

It is an additional aspect of the present invention to provide a system that automatically detects parameter changes by keeping copies of known current operating parameters, and by periodically automatically comparing the copies to the actual production working parameters.

It is another aspect of the present invention to provide a system for automatically propagating detected changes in telephone network operating parameters among cooperating telephone network operators.

It is an additional aspect of the present invention to provide a system for automatically propagating detected changes in telephone network operating parameters among cooperating telephone network operators.

It is still another aspect of the present invention to provide a system for maintaining a central directory of operating parameters and values.

It is an aspect of the present invention to provide a system for maintaining a central directory of operating parameters and values that receives updates when corresponding production parameters and values are updated, and that can serve as a source for propagating updates.

It is another aspect of the present invention to provide a system that receives initial and/or updated parameters from a central directory or repository which the network operator may then use to operate its network.

It is another aspect of the present invention to provide a system that automates the flow of parameters between mobile operators and SCCP gateways.

It is another aspect of the present invention to provide a system for updating a copy of remote operating parameters with updates originated directly by the corresponding remote network operator or indirectly by the same using a central server or other type of shared resource.

The above aspects can be attained by a system and method for synchronizing operating parameters among telephone network operators, and in particular mobile network operators. Each operator operates a telephone network according to values of private or production operating parameters maintained by the operator. The system may have connectivity or access to the production operating parameters and values maintained by a first operator. The system automatically detects a new operating parameter or value maintained by a first operator and in response uses a data network to automatically cause a second mobile network or telephone network operator to update its operating parameters or values to reflect the new or updated local parameter of the first operator.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIGS. 1-4 show an example of a technical document 10 exchanged between operators that have agreed to handle each other's roaming customers.

FIG. 5 shows a typical arrangement of mobile operators 20.

FIG. 6 shows a general arrangement of one aspect of the invention.

FIG. 7 shows a general process of the update system 40.

FIG. 8 shows some components of a preferred embodiment of the update system 40.

FIG. 9 shows a preferred construction of an IS 60.

FIG. 10 shows a possible construction of the central repository or database 66.

FIG. 11 shows a general outgoing flow of updates or changes to parameters/values.

FIG. 12 shows a general flow of the home monitoring or “watchdog” process of an IS.

FIG. 13 shows process by which the CS 62 handles update messages.

FIG. 14 shows a process by which an IS handles updates messages relayed 208 from the CS 62.

FIG. 15 shows a process for IS's to check roaming parameters.

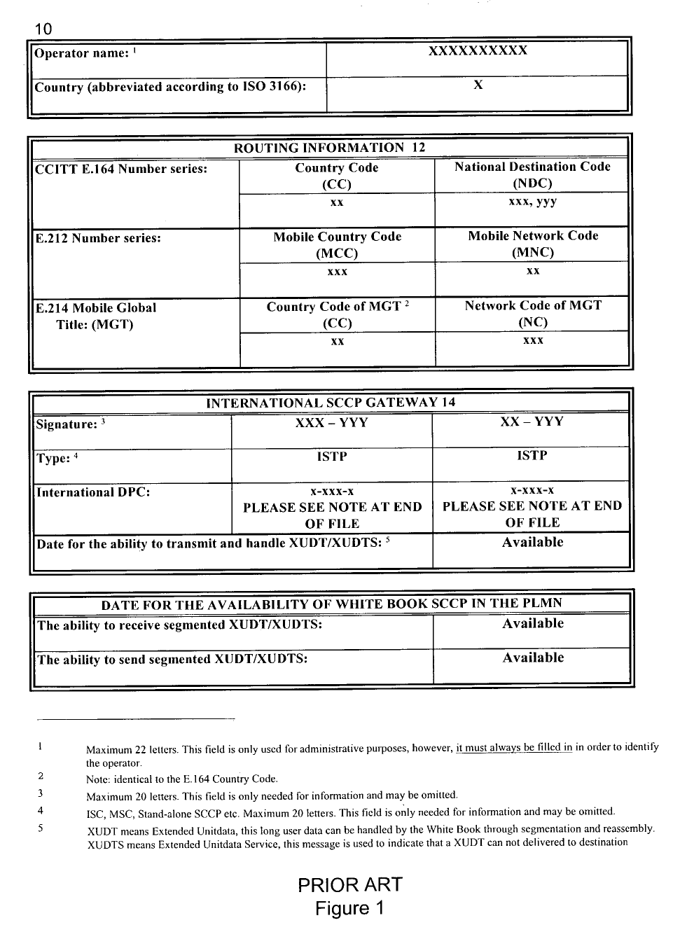

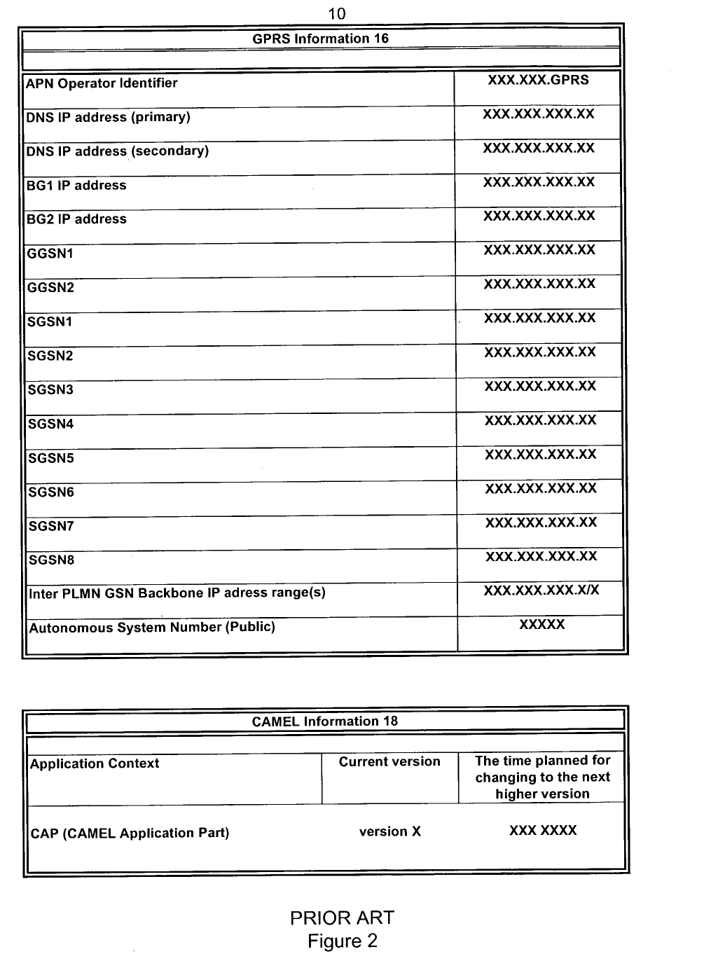

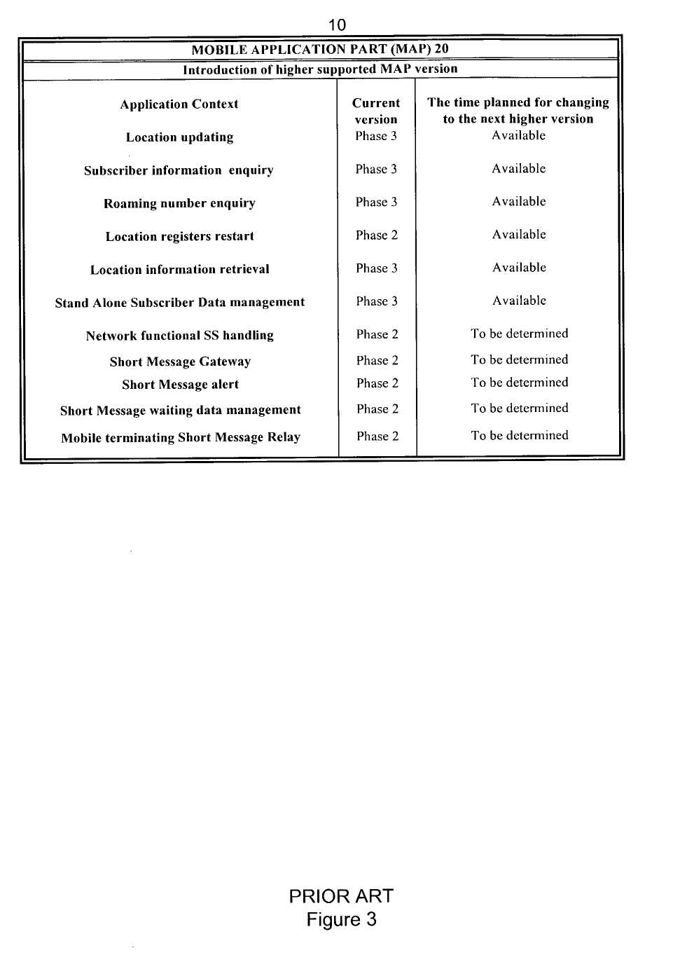

### DETAILED DESCRIPTION OF THE PREFERRED EMBODIMENTS

Roaming Problems Caused by Incorrect Parameters

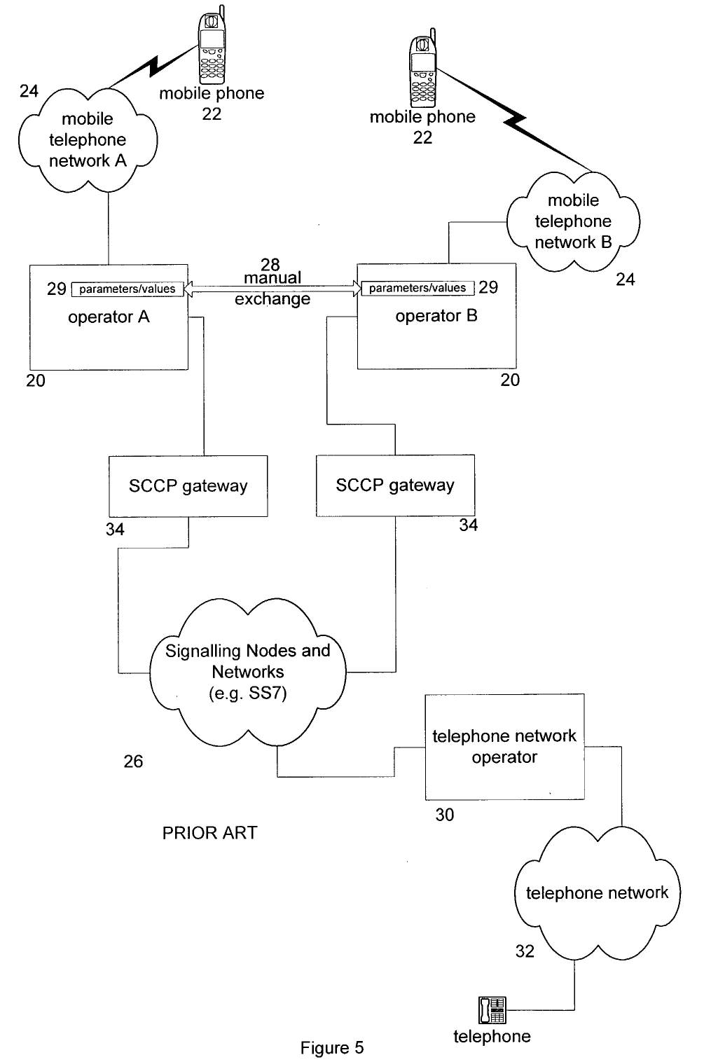

FIG. 5 shows a typical arrangement of mobile operators 20. The mobile operators 20 handle mobile calls to/from cell or mobile phones 22 using mobile telephone networks 24. When a call has to be routed outside of an operators 20 mobile telephone network 24, telephony signalling nodes or networks 26, for example Signalling System 7 (SS7), may be used for call control or carrying call control signalling messages.

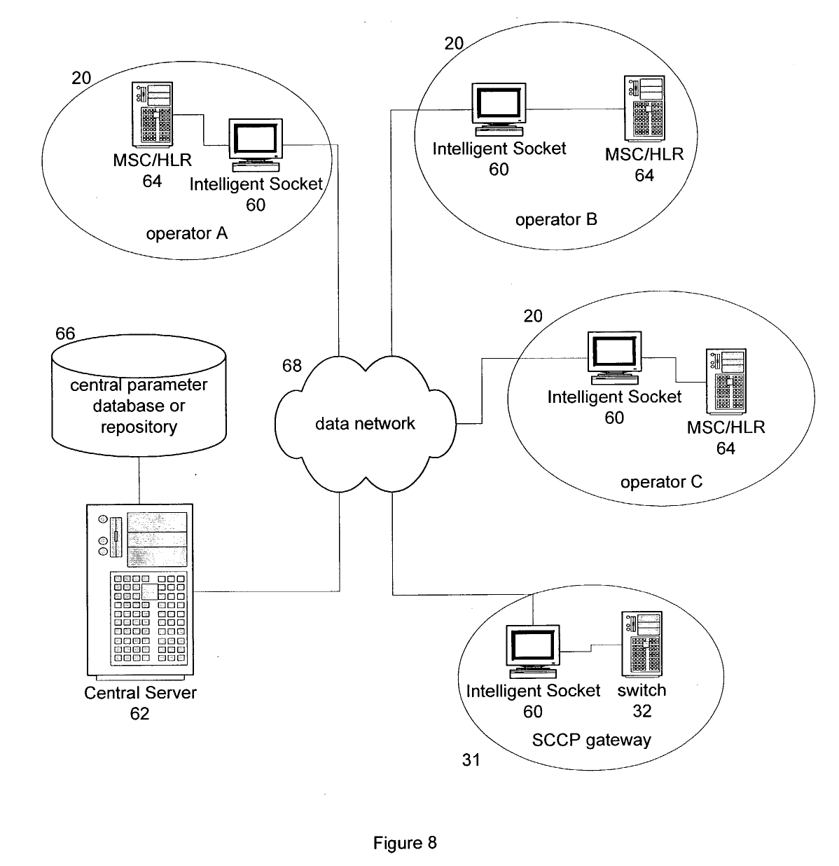

In particular, roaming mobile calls require information such as network or telephony signalling information of the operator 20 of the called/calling mobile phone 22. This information may be referred to as network operating parameters and their values. Typically, when two operators 20, for example operator A and operator B, have formed a roaming agreement, they would manually exchange 28 such network operating parameters 29. The exchanged 28 parameter information 29 would then be manually entered into systems such as Mobile Switching Centers (MSCs) and HLRs (see FIG. 8) of the respective operators 20, and from these parameter information 29 would then be used in the handling of calls by the network operators 20. Similar exchanges and use of information may occur with non-mobile telephone network operators 30 operating telephony signalling nodes, networks, switching control (SCCP) gateways 34, etc. that may be involved in handling a telephone call.

As background information, mobile calls generally use a subscriber's International Mobile Subscriber Identity (IMSI). In the case of Global System for Mobile communications (GSM) networks, the IMSI is a 15 digit number. It is composed of three codes ordered as follows: a Mobile Country Code (MCC, 3 digits), a Mobile Network Code (MNC, 2 digits), and a Mobile Subscriber Identification Number (MSIN, 10 digits). In other words, an IMSI=MCC-MNC-MSIN=xxx-xx-xxxxxxxxxx. The MCC and the MNC respectively define the country and the network number for the network operator subscribed to by the subscriber.

A problem related to a roaming arrangement is explained below by way of examples. In the examples it is assumed that two network operators A and B have formed a roaming agreement or arrangement and have manually exchanged related technical documents such as IR21s, from which they used parameters/values to configure their respective equipment/network used to handle each other's calls. The example also assumes the existence of a subscriber of operator A (referred to as subscriber A) and a subscriber of operator B (subscriber B).

In a first scenario, the mobile telephone of subscriber A (now called telephone A) is switched on while visiting an area serviced by network operator B. Telephone A transmits the IMSI number that is stored on its Subscriber Identification Module (SIM). Telephone A's IMSI is received by the VLR (Visited Location Register) of operator B (VLR-B) that is responsible for the cell where the telephone A is located when switched on.

Operator B's VLR-B, having received the IMSI of subscriber A, extracts from the IMSI the MCC and the MNC that define respectively the country and the network number for operator A. Then, the VLR-B contacts the HLR of operator A (HLR-A), informs it that the considered roamer (subscriber A) is in its cell or area, and asks the HLR-A to send information regarding the services to which the roaming subscriber A is entitled. Finally the VLR-B assigns to roaming subscriber A a Temporary Mobile Subscriber Identity (TMSI) that will be used to communicate with subscriber A instead of subscriber A's IMSI.

The identification process described above is known as a “location update”. The success of a location update depends on the correct implementation of the reference parameters regarding operator A in the various databases and mobile/telephony equipment (e.g. HLR-B, MSC-B) of operator B. If some of those parameters are incorrect or not current, then the subscribers of operator A visiting the area serviced by operator B may be unable to get the expected services such as incoming/outgoing calls, Short Message Service (SMS), WAP (Wireless Access Protocol), etc., due to, for example, operator B's inability to identify subscribers of operator A's or operator B's inability to route or setup their calls (in turn caused by a parameter mismatch). For instance, the MCC and MNC extracted from the IMSI must first be translated respectively into Country Code (CC) and Network Code (NC) parameters in order to be used by operator B to identify roamers subscribed to operator A and in order to contact the corresponding HLR-A of operator A. If the NC for operator A that is stored in the MSCs and HLRs of operator B is incorrect, roamers from operator A will not be recognized by operator B, thus preventing the completion of the location update process in areas serviced by operator B. As a consequence, the subscribers of operator roaming in operator B's area will be unable to use their mobile phones.

Previously, the Infocenter web site (infocentre.gsm.org) maintained by the GSM association has been used as a repository of information relating to operating parameters relevant for enabling roaming between network operators. This web site hosts a database of IR21 documents for each network operator member of the association. When a network operator adds or modifies some parameter he may manually inform the DB managing team of the Infocenter by manually sending a notification of the modification. The notification is usually in the form of an “Annex to the IR21”. Then the Infocenter DB team implements the modification by hand in the Infocenter database. Alternatively, operators can directly implement parameter modifications by editing the fields of their IR21 from the web page of the Infocenter.

Following the manual update by the DB managing team, the Infocenter or managing team may send an update notification to the other network operators informing them at most that the given operator modified its IR21. The notification does not contain any detail about the actual parameter update and therefore the operators affected by the change must either access the IR21 database of the Infocenter or directly contact the given operator to get this information. Furthermore, it must be manually determined whether an operator is affected by an update (i.e. whether an operator has a roaming agreement with the originator of the change).

The lack of automation at many steps of the Infocenter workflow strongly limits the usefulness of the Infocenter IR21 database as a means for parameter exchange between operators. In practice, most of the operators do not timely update their changes at the Infocenter. Many do not update them at all. When they do, the changes are prone to manually-introduced transcription errors. As a result, operators still contact directly and manually each of their roaming partners to deal with parameter update matters.

In sum, incorrect parameters result from two main causes: human error; and obsolescence. Obsolescence may be understood by another hypothetical scenario. When a network operator introduces a new parameter (required for a new service, numbering plan extension, new switch, etc.), the network operator must notify network operators with whom it has roaming agreements, and ask them to implement the update as soon as possible (for example, by manually updating their parameter databases). In practice, each network operator that receives such update requests processes the update requests at their own pace, and therefore, parameters usually remain obsolete for a certain amount of time. That is to say, the parameters maintained and used by network operators to accept or route roaming calls are often out of synchronization with corresponding information maintained by a roaming subscriber's network operator.

Another example is related to the case of an incoming call to a subscriber A of network operator A while roaming in an area serviced by network operator B. Suppose that the call is originated by another subscriber of operator A located in an area serviced by operator A. In the following the terms “origin” and “destination” designate respectively the calling and the called subscribers. When the origin dials the phone number of the destination that is its Mobile Station International ISDN Number (MSISDN), the call request reaches the Mobile Switching Center (MSC) of operator A. The MSC queries the HLR-A of operator A for the location of the destination. The HLR-A stores the identity of the last VLR from which the destination performed a location update. Using this information, the HLR-A contacts the relevant VLR-B of operator B and asks for a Mobile Station Roaming Number (MSRN) in order to rout the incoming call toward the destination. The HLR-A relays the received MSRN to the MSC which then routs the incoming call to the destination.

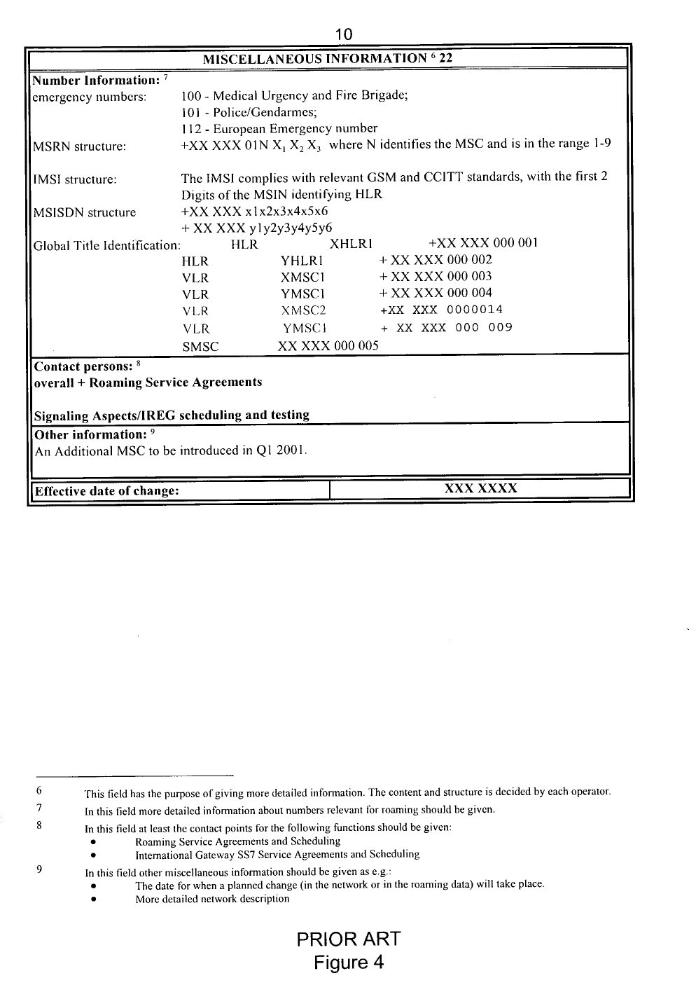

As discussed above, the MSRN is assigned upon request (e.g. by an incoming call) and can therefore change at each call. However, the set of MSRNs used by the destination network, here network operator B, is constant and defined as the MSRN “range” in the set of reference parameters exchanged between operator A and operator B (see the portion of the example IR21 document 10 shown in FIG. 4). The MSRN range of operator B must be implemented in the switches of the international SCCP gateway for operator A in order to allow the use of any of the numbers in the range as an MSRN for subscribers of operator A roaming in an area serviced by operator B.

Assume that operator B introduces a new MSRN range. The roaming team for operator B is supposed to manually and promptly inform its counterpart in operator A about the change. The roaming team at operator A is supposed to relay the update immediately to its international SCCP gateway. Eventually, technicians of the SCCP gateway will implement the new MSRN range in their switches. If for some reason the update is not implemented at the SCCP gateway at the moment operator B assigns MSRNs from the new range, subscribers from operator A will not be able to receive incoming calls while roaming in areas serviced by operator B, because operator A's SCCP gateway will be unable to make use of the new MSRN numbers at its switches.

Another example could be a problem of SMS delivery to or from roamers because of outdated or incorrect SMS Center (SMSC) addresses implemented in the databases of the roaming partners (see the portion of the example IR21 document 10 shown in FIG. 4). More recently, the introduction of mobile data services such as General Packet Radio Service (GPRS) or Wireless Access Protocol (WAP) involved the addition of new parameters that must be implemented by roaming partners in order to offer these advanced services to roamers. Although GSM networks offer the most geographically extended international roaming, other standards such as ANSI-41 (CDMA & TDMA) also offer some international roaming possibilities to their subscribers. Therefore the problems of parameter update described above are also relevant to these networks.

Incorrect or missing parameters have been manually detected and traced from their symptoms, for example by following or investigating complaints of customers that are unable to get a given service (e.g. incoming/outgoing calls, SMS, data service, etc.). When a complaint is recorded by the customer care service of operator A or operator B, a tedious and time consuming process begins. Technicians of operator A and operator B, as well as technicians of their respective SCCP gateways, search manually for the error in their respective databases. Customers are unable to get their service until the error is found and corrected. As a result, subscribers in a roaming situation receive poor service, and network operators experience loss in the form of customer turnover and increased cost. Moreover, network operators loose the opportunity for additional revenue when calls cannot be placed by roaming subscribers.

In summary, the whole process of parameter exchange and update between operators has been completely manual, non-centralized, and asynchronous. Moreover, the errors that sometimes result from the above-described manual parameter management methods are treated in an inefficient way. The situation is similar with international SCCP gateways.

Overview of System and Method for Solving Parameter Problem

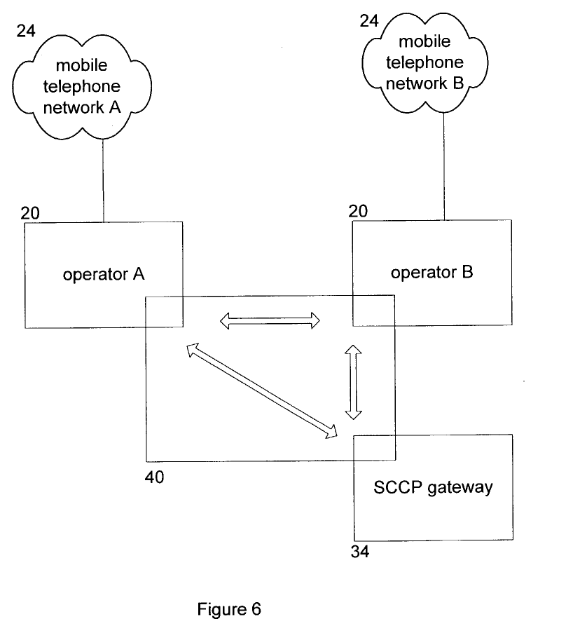

FIG. 6 shows a general arrangement of one aspect of the invention. Mobile network operators 20 and an SCCP gateway 34 share a parameter exchange or update system or apparatus 40. The parameter exchange system is a system by which parameter updates are automatically detected and propagated or distributed amongst the operators 20, and SCCP gateways 34. The overlaps of the update system 40 with the operators 20, and SCCP gateways 34 reflect electronic communication, preferably by data network, between the system and the operators 20, and SCCP gateways 34.

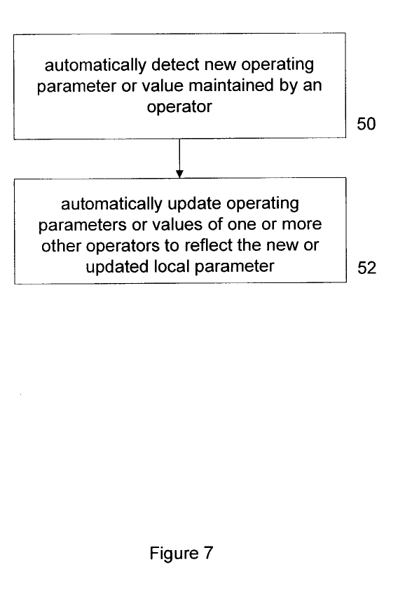

FIG. 7 shows a general process of the update system 40. The update system 40 will first automatically detect 50 a new operating parameter or value thereof maintained by an operator 20, and SCCP gateways 34. The update system 40 will then automatically update 52 (or cause to be updated) operating parameters or values of one or more other operators 20, and SCCP gateways 34 to reflect the new or updated local parameter. The parameters mentioned herein will generally be of the type in an IR21 or other document, although others may be used in other circumstances, particularly where GSM is not involved.

Client-Server Embodiment Using Central Server and Intelligent Sockets

FIG. 8 shows some components of a preferred embodiment of the update system 40. The general architecture shown in FIG. 8 is a client-server architecture. The clients are shown as Intelligent Sockets 60 (hereafter referred to as “IS”). The server is Central Server 62 (hereafter referred to as “CS”). The IS 60 of each operator 20, and SCCP gateways 34 will have access to stored working or production parameters and values of their respective operator. The production parameters/values are those used by the operator to receive, handle, route, etc. calls. The parameters/values will usually reside in equipment or databases 64 of the operator, such as an MCS, a HLR, and so forth 64. The IS 60 may access the databases or equipment 64 or parameters in any number of ways. If the IS 60 is hosted by one of such equipment 64, then the access may be direct (e.g., interprocess communication). The access may be by way of a local network of the operator, a phone line, a wireless communication channel, etc.

The CS 62 will preferably have a database or data repository 66 where last known copies of the parameters/values of the operators will be maintained. With such database 66, the CS 62 can be used, among other things, as a convenient source to initialize the parameters/values of an operator (or IS 60 thereof) that has entered a new roaming agreement. As discussed in detail later, the CS 62 and database 66 can also be used to store and forward updates to the non-originating operators affected by the same.

Because the IS 60 of an operator will have access to production parameters/values affecting the operation of the operator's network, security is important. For this reason, the client-server design may be preferable. This allows an operator to retain control over how its parameters are read and updated, what parameters may be accessed, a period of accessing the parameters, and so on. Furthermore, different operators can have different types of equipment or databases 64 hosting their parameters. Therefore, each operator will be best able to adapt an IS 60 to the particularities of its own network and parameter sources. However, architectural designs other than the client-server design of FIG. 8 are possible. As discussed later, server-only or client-only designs are also feasible. What is important is the provision of a common conduit and logic for detecting and sharing updates among operators.

Finally, a data network 68 will preferably be used to enable communication between the various IS 60s and the CS 62. The network 68 will preferable be a general purpose packet-switched data network, such as a TCP/IP network. The Internet may be used as the network 68. It is also possible to use the network layer of a Signalling System 7 network. The network 68 may be accessed at the network level directly by the IS 60 and CS 62. Or, an application-level protocol may used on the network 68. For example, any of SMTP, FTP, HTTP, TFTP, LDAP, etc. may be used for communication between the IS 60s and the CS 62.

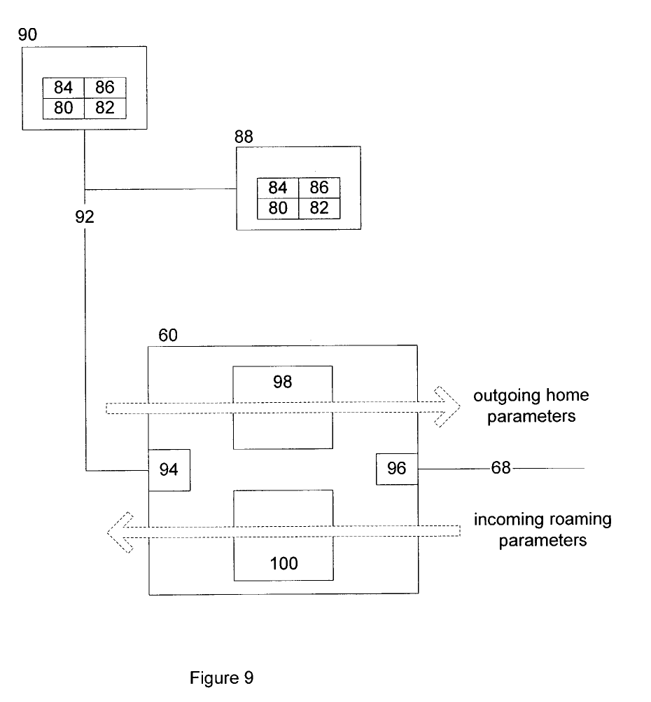

FIG. 9 shows a preferred construction of an IS 60. As discussed above, the IS 60 will have access to its operators working or production parameters/values 80/82 (home), 84/86 (roaming partners), as stored in an MSC 88 or HLR 90, for example. A communication path 92 is accessed with an interface 94. The data network 68 may be accessed with another interface 96.

Preferably, each IS 60 will have two databases or sets of data that it stores; a home parameters database or dataset 98, and a roaming parameters database or dataset 100. As shown by the dashed arrows and discussed in detail later, an IS 60's operators home parameters will flow from the operator's production parameters/values 80/82, etc., to its IS 60 (and dataset 98), and from there through the data network 68 to the CS 62 (or other IS 60s in the case of a client-only peer-to-peer type architecture). Conversely, roaming parameters of other operators will flow in from the CS 62 through the data network 68, will be stored or cached in the roaming parameters dataset 100, and from there will flow to the various production parameters (e.g. parameters/values 84/86) of the various telecommunications devices of the IS 60's operator. For instance, an MSC makes use of an MSRN to route an incoming call to a subscriber roaming in an area serviced by another network operator.

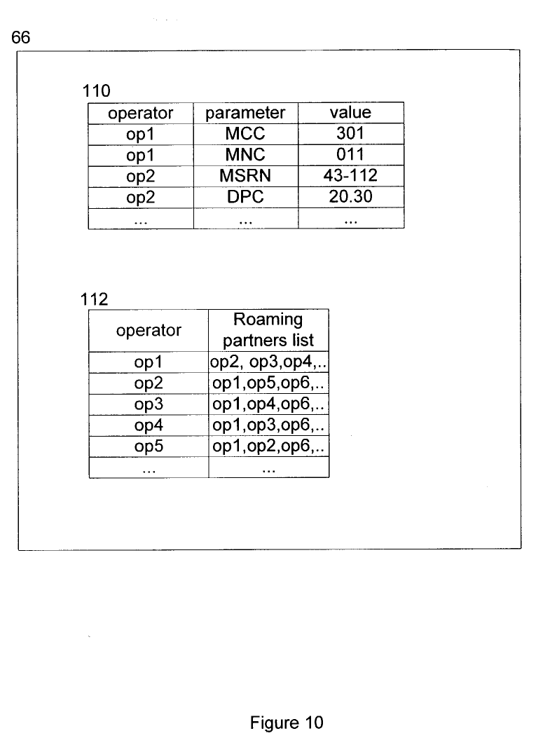

FIG. 10 shows a possible construction of the central repository or database 66. A table 110 may be used to store parameters/values for participating network operators. A list or table 112 of networks in roaming agreements may also be maintained and used to limit the scope of updates to only those network operators affected by the a given update. Many different table arrangements and additional fields are also possible.

General Flow of Updates

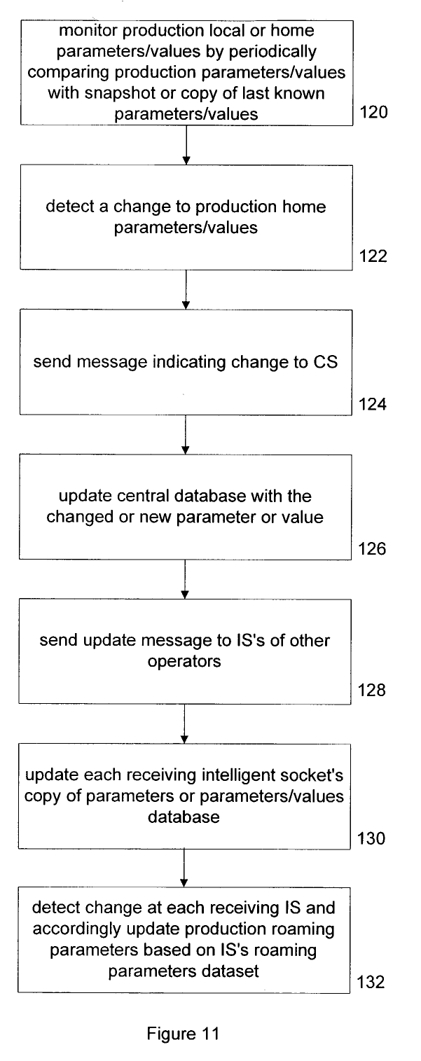

FIG. 11 shows a general outgoing flow of updates or changes to parameters/values. An IS 60 monitors 120 production local or home parameters/values (those in use by network equipment) by periodically pulling and comparing the production parameters/values with a snapshot or copy of last known parameters/values, which may be the home parameters dataset 98. When a change in the production parameters/values is detected or determined 122, a message indicating the change is sent 124 to the CS 62 through the data network 68. In turn, the CS 62 will update 126 the central database 66 and parameters table 110 with the changed or new parameter or value. The CS 62 will then send 128 update messages to the IS's 60 of the other operators 60 (or possibly just those affected), and each receiving IS 60 will update 130 each receiving IS's copy or dataset of roaming parameters/values (roaming parameters dataset 100). Finally, each receiving IS will detect 132 the change at its receiving IS and accordingly update production roaming parameters based on the IS's roaming parameters dataset.

The processes mentioned above are described in detail below with reference to various IS and CS processes.

Home Parameters Watchdog Process

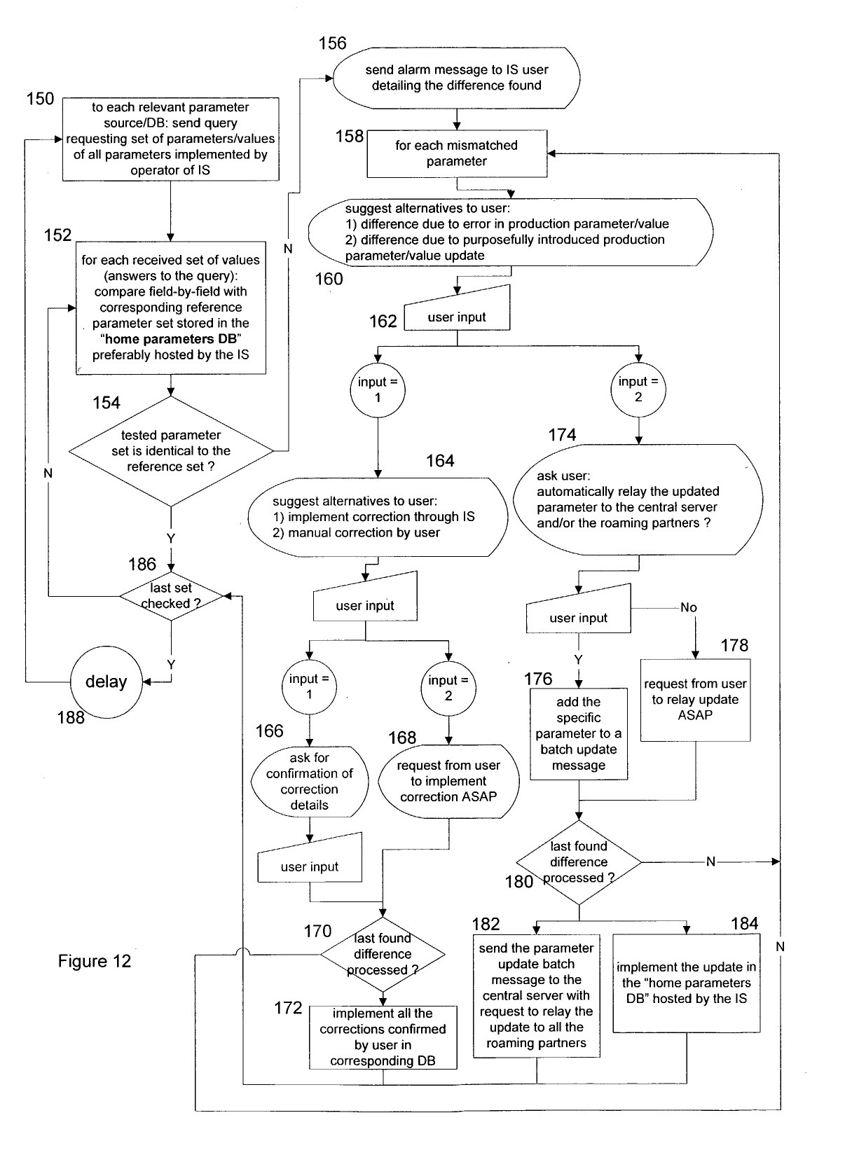

FIG. 12 shows a general flow of the home monitoring or “watchdog” process of an IS. The purpose of this home parameters watchdog process or function is to automatically detect and forward changes in the home production parameters (e.g. parameter/value 80/82) of the network that operates the IS and that are of interest for roaming partner operators.

The main control loop of the watchdog process begins when it sends 150 to each relevant parameter source/DB (e.g. a production data used by equipment such as an MSC), a query requesting the source's set of production parameters/values. For each received set of production parameters/values, the process compares 152 field-by-field the parameters values with corresponding parameters/values stored in the home parameters dataset/DB 98. If a tested parameter set is 154 not identical then an alarm message is sent 156 to a user that details the difference found by the comparing 152.

For 158 each mismatched parameter of the current set of production parameter/values, alternatives are suggested 160 to the user. According to user input 162, the alternatives may be to one of 164 implement a correction automatically by the IS, or manually correct the discrepancy, or 174 automatically relay the updated parameter to the CS (or to roaming partners in a peer-to-peer system). If the user decides to implement the correction with the IS, then, according to user input (½) the IS may ask 166 for confirmation or adjustment of the correction details (which are known already to the IS from the compare process 152). Or, the user may opt to immediately 168 implement the correction. If the user concluded 174 that the difference is due to a purposefully introduced update, he or she may decide to either 176 send automatically the update to the CS as part of a batch or to send the update at a later stage 178. Stages 158 to 180 are repeated until 170, 180 the last parameter difference is processed. Further sets or sources of sets are processed 152 until 186 the last set has been processed. A delay 188 may help to prevent excessive use of the operator's resources.

In the paragraph above, it can be seen that the path from stage 164 to 172 is chosen when there is an erroneous production parameter/value and the home parameter dataset 98 is correct. The path from stage 174 to 182 and 184 is chosen when the production parameter/value is determinative, and the IS and CS must be updated accordingly. According to the nature of the discrepancy, a correction will be made 172 to the production parameter/value (or the production DB where it resides), such as for example parameter/value 80/82. Or, a correction will be sent to the CS 62 and will be implemented 184 in the home parameters dataset 98 of the IS 60 executing the watchdog process.

Furthermore, it will be appreciated that in general user intervention may not be required, or may be added at other points. The home parameters database or dataset 98 is initialized by copying the values of all the required parameters implemented in the operator's network.

Again, any difference detected 154 at a given moment between the reference parameters 98 at the IS and the production parameters returned by the query 152 induces an automatic alarm message to the user (by email for example). The supervisor determines if the difference is caused by an error and in this case if he or she wishes to correct the error through the intelligent socket, that is allowing the intelligent socket to correct the error directly in the considered production database or configuration storage of the network operator, or alternatively if the difference corresponds to a planned modification of some network parameter. In the later case, upon acknowledgement from the user, the IS prepares and sends 182 an update message for the CS detailing the parameter modification and updates 184 the local home parameter dataset 98 of the IS.

In order to avoid multiple partial update message transmissions, the IS will preferably send 182 the update message to the CS as a batch after the completion of the test loop, that is, when the last parameter set returned from the last database queried has been tested for changes.

Management of Incoming Parameter Updates

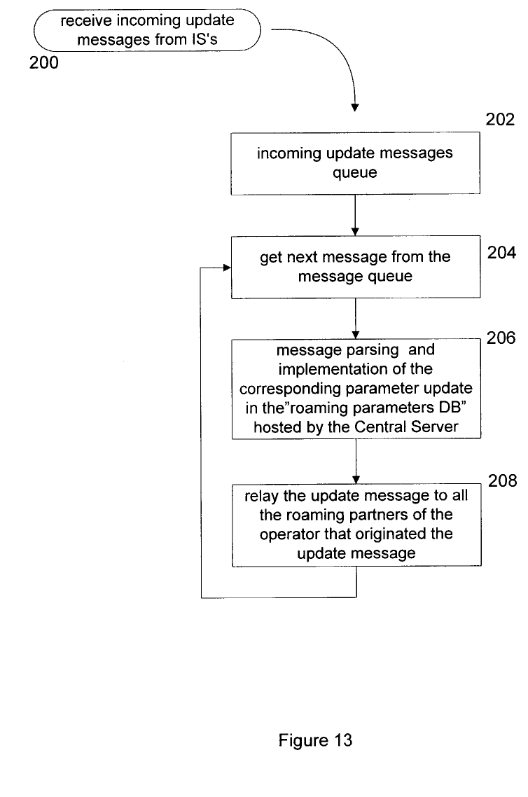

FIG. 13 shows process by which the CS 62 handles update messages. The CS 62 receives 200 incoming update messages from the various IS's 60 over the data network 68. The messages go into an incoming message queue 202. The next message is gotten 204 from the message queue 202. The CS 62 parses and implements 206 the message by updating its database 66 and parameter table 110. The parsing will involve extracting information such as the identity of the operator that generated the update message, the nature and value of the updated parameters, etc.

The CS 62 then relays 208 the update message to all of the roaming partners of the operator that originated the update message, according to the roaming list table 112. Alternatively, the roaming list table can reside at the IS's, and the CS can send all update messages to all of the IS's, each of which decides whether the update relates to a roaming partner.

Handling of Updates by Intelligent Socket from Central Server

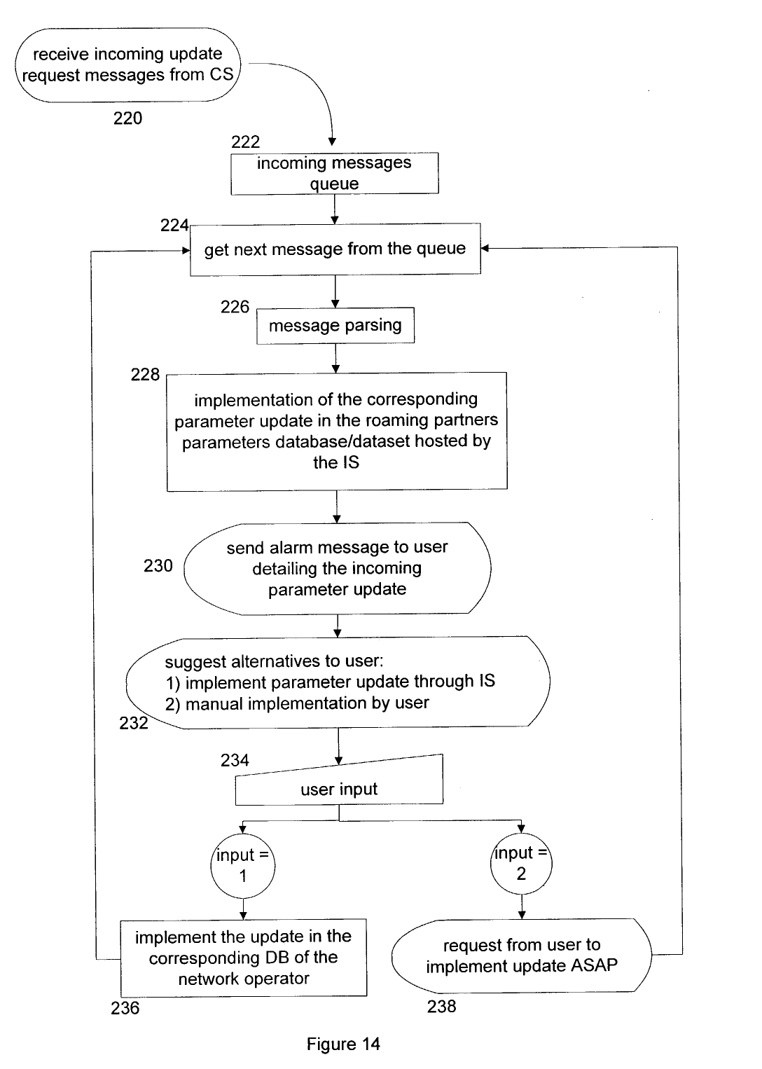

FIG. 14 shows a process by which an IS handles update messages relayed 208 from the CS 62. The IS receives 220 incoming update request messages relayed or sent 208 from CS 62 over the data network 68, into incoming messages queue 222. The IS gets 224 the next message from the queue 222. The message is parsed 226 and its update is implemented 228 into the corresponding parameter update in the roaming partners parameters database/dataset 100 hosted by the IS. The parsing 226 will typically extract information such as the identity of the operator that generated the update message, the nature and value of the updated parameters, etc.

The IS sends 230 an alarm message, email, notice or the like to a user. The alarm message details the incoming parameter update. Alternatives are suggested 232 to the user: (1) implement parameter update through IS; (2) manual implementation. According to one user choice or input 234, the IS automatically implements 236 the update in the corresponding DB or production parameter/value of the IS's network operator (e.g. the parameter/value 84/86 of network device 88/90). Or, according to a second user choice, the IS requests 238 a manual user implementation of the update.

Because the IS has implemented the update by updating its roaming parameter database 100, its roaming parameter watchdog process (discussed below) can detect local differences between production parameters/values (e.g. the parameter/value 84/86) and the correct parameters/values in the roaming parameter database or dataset 100, whose parameters/values should match the central database 66.

The manual intervention is not required; it is also possible to always automatically update 236 the production parameter/value. This approach might be accompanied by an automatic notice to a user or operator to verify the result of the automatic update.

Roaming Parameters Watchdog

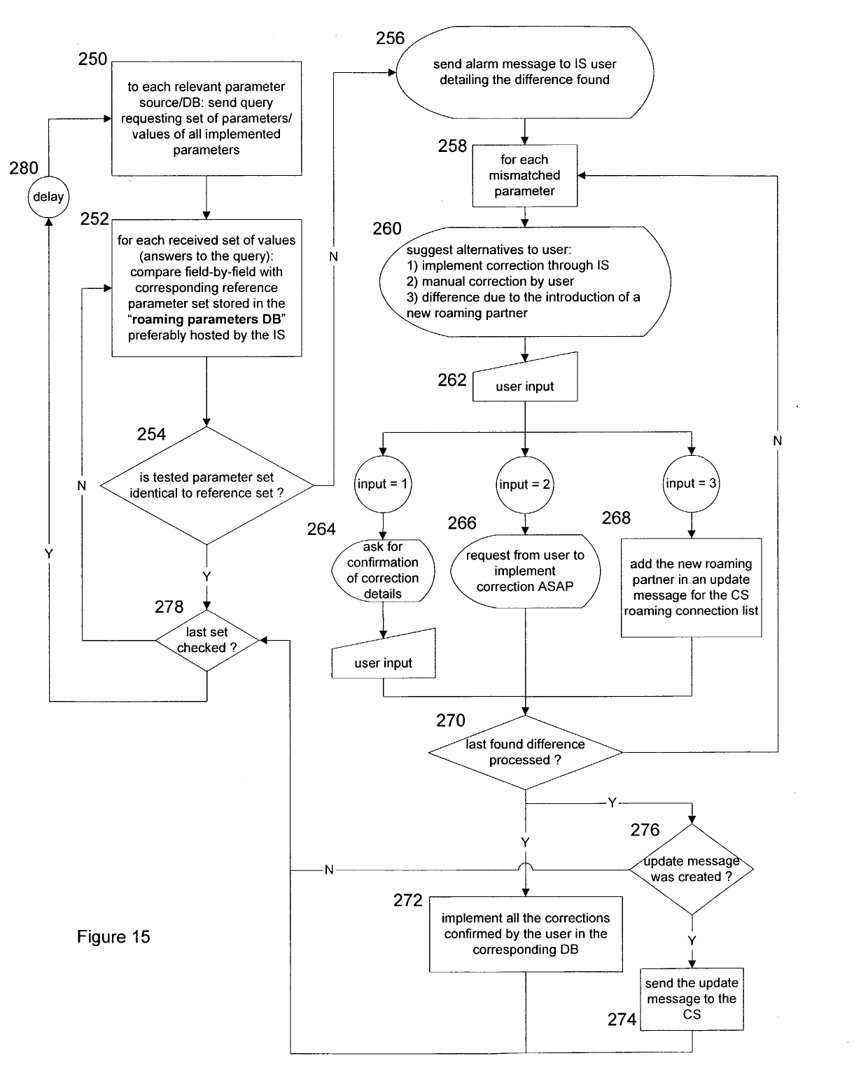

FIG. 15 shows a process for IS's to check roaming parameters. The purpose of this function is to ensure that parameters related to roaming partners, that must be implemented in the databases or devices of a network operator, are correct and up to date or synchronized. For this purpose the intelligent socket sends periodical queries to the production parameter sources databases of the network operator.

Initially, the IS will send 250, for each relevant production parameter source or database, a query or request requesting a set of parameters/values of all implemented parameters. For each received set of parameters/values (answers to the query), the IS will: compare 252 the parameters/values field-by-field with a corresponding reference parameter set stored in the roaming parameters dataset 100, which is preferably hosted by the IS. If 254 the tested parameter set is not identical to the reference set, then the IS will send 256 to an IS user an alarm message, e-mail, notice, etc. detailing the difference found. For each 258 mismatched parameter, the IS will suggest 260 alternatives to the user: 1) implement correction through IS; 2) manual correction by user; 3) difference due to the introduction of a new roaming partner. According to user input 260, the IS will ask for confirmation 264 of correction details, request 266 from user to implement correction ASAP, or add 268 the new roaming partner in an update message for the CS roaming connection list. When 270 the last found difference is processed, the IS implements 272 all the corrections confirmed by the user in the corresponding production equipment or DB (e.g. the parameter/value 84/86 at device 88/90). For instance, an MSC makes use of an MSRN to route an incoming call to a subscriber roaming in an area serviced by another network operator.

If 274 an update message was created, the IS send 276 the update message to the CS. If 278 the last set that was requested 250 and received 252 has been checked 254, then a delay 280 is taken to avoid processing and network saturation, and the process repeats.

The roaming parameters database 100 can be initialized either by copying the values of all the roaming partners parameters implemented in the network at initialization time, or by downloading them from the CS, which, as mentioned above, hosts a database 66 of the roaming parameters 110 for all the network operators. Moreover, the roaming parameters/values dataset 100 is kept up-to-date by the incoming update messages relayed 208 by the central server.

Any difference detected at a given moment between the roaming reference parameters in the dataset 100 and the parameters returned or received 252 by the query induces an automatic alarm message to the user. The user must decide if the difference is caused by an error or a lack of updating and in this case if he or she wishes to correct the parameter through the IS, which will entail allowing the IS to correct the wrong or out-of-date production parameter directly in the considered database. Alternatively, the user may decide the difference corresponds to the planned introduction of a new roaming partner. In the later case, the IS prepares an update message specifying the new roaming partner to be added to the roaming connection lists 112 maintained for each operator by the CS. In order to avoid multiple partial update messages, the IS will preferably send the update message to the CS after the completion of the main loop; when the last production roaming parameter set returned from the last database queried has been tested for changes.

The “watchdog” functions of the IS's described above allow the automatic detection of discrepancies such as wrong, missing, or obsolete parameters in the operator system. They also avoid the tedious and time-consuming task of identifying error(s) manually as discussed above. Although the watchdog functions will mainly operate on a periodical basis, they can also be triggered by a customer complaint or some other event. Furthermore, parameter checking can be directly triggered by existing network monitoring systems when they detect roamers that try without success to connect to the hosting network.

In the system described above, the CS and its database of the roaming parameters for all the network operators is of significant use for new operators which need to initialize their parameter databases. The central server allows the download of the requested parameter set and its immediate and error free implementation into the operator's databases by the IS. Another important role played by the CS is the introduction into the system of parameters from network operators that choose not to install an IS. Since such operators can have roaming agreements with operators that use intelligent sockets, their roaming parameters must be available to the intelligent sockets of their roaming partners around the world. Therefore, the easiest way to introduce into the system data available only “manually” is to do it at a node accessible to all the IS's, that is at the CS. This way, operators that use an IS get automated access to all the roaming parameters they need.

### EXAMPLE AND FURTHER DESCRIPTION

To illustrate the information flow through the system, an example is given. An operator A might introduce a new parameter, for instance a new National Destination Code (NDC). Perhaps responsive to the introduction of the new NDC, or by other mechanisms, the IS of operator A will automatically generate an update message that will be sent to the CS. The CS receives the update message, updates its own database accordingly, and may then relay the update message (or corresponding messages) to operator A's roaming partners (network operators that have signed a roaming agreement with operator A).

The central server may also relay update-related messages to international SCCP gateways that provide a corresponding international signaling link. For this purpose, the CS stores, for each operator, a roaming connection list that enumerates the roaming partners of a given operator, as well as the involved international SCCP gateways. As discussed above, the IS's have querying access to their operator's databases (or configuration information), allowing them to detect newly implemented production parameters. When a network operator opens a new roaming destination following the signature of a new roaming agreement, he will implement the parameters for the new roaming partner in its databases. The introduction of the new parameters will be detected by the IS. This will result in an automatic update message to the CS that will update the roaming connection list for the considered operator.

It is also possible for an IS to avoid any state information and to use the Central Server's database 66 directly. The home and roaming parameters maintained by the IS could instead be cached mirrors of data in the database 66.

A client-only peer-to-peer architecture is also possible, where the roaming parameters are mirrored or fully maintained at each of the IS's. Each would essentially function as both a client and a Central Server. A server-only architecture is also possible, where the CS has access to each operator in the same fashion of an IS.

In practice, the amount of data exchanged between network operators for parameter updating purpose is generally small. Nowadays, typical GSM operators receive between 3 to 5 different parameter updates per day from their roaming partners. Considering that network operators do not have roaming agreements with all the other existing operators, the total number of updates issued by all existing GSM operators around the world is about twice as much as the number of daily updates received by a typical operator. This means that the Central Server typically receives about 10 incoming update messages a day. These messages in turn, will generate a number of relayed update messages equal to the number of Intelligent Sockets installed worldwide, which in the best case equals the number of existing network operators and international SCCP gateways. In the case of GSM, as of the time of filing this specification, there were about 700 network operators worldwide and a few dozens of international SCCP gateways, giving an upper bound of 1000 outgoing messages per day. Considering this small volume of data, a possible embodiment of the system would use email messages as a communication means between the local Intelligent Sockets and the Central Server.

The discussion above primarily refers to roaming between cellular network operators. Due to widespread use and standardization, the system and method described above are particularly well-suited for GSM networks. However, the system and method can also fit the needs of other mobile networks allowing some kind of roaming, such as ANSI-41 networks, as well as any evolution of current networks such as W-CDMA (Wide band code division multiple access code), Edge (Enhanced data rate for GSM Evolution), UMTS (Universal Mobile Telecom. System), 3G (third generation networks), etc. The system can also fit the needs of existing networks introducing advanced services such as MMS (Multi-media short Message Service) and others. Furthermore, emerging WLAN standards such as the IEEE 802.11 b (known to the public as “wifi”) are beginning to offer some roaming possibility to cellular internet users, creating new needs for the exchange of roaming parameters between cellular operators and small WLAN internet providers, thus extending the potential use of the system and method. Data clearinghouses could also benefit form the system since they currently make use of IR21 information to identify the home network of a subscriber that places roaming calls, thereby enabling placement of a price “tag” on these calls.

Another aspect of the communication between the Intelligent Sockets and the Central Server is security, that is to say, protecting the data transmitted as well as the information systems at both ends such as Intelligent Sockets, network operators databases, the Central Server, etc. For this purpose, well known methods from prior art, such as encryption and firewalls are used by both the Intelligent Sockets and the Central Server.

The present invention has been described with respect to a system and method for synchronizing operating parameters among telephone network operators, and in particular mobile network operators. Each operator operates a telephone network according to values of private or production operating parameters maintained by the operator. The system may have connectivity or access to the production operating parameters and values maintained by a first operator. The system automatically detects a new operating parameter or value maintained by a first operator and in response uses a data network to automatically cause a second mobile network or telephone network operator to update its operating parameters or values to reflect the new or updated local parameter of the first operator.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method, comprising:
automatically detecting new, incorrect, or out-of-date network parameters exchanged between and commonly used by public telecommunication network operators.

2. A method according to claim 1, wherein the parameters are roaming parameters and wherein the public telecommunication network operators comprise mobile network operators.

3. A method according to claim 2, further comprising automatically correcting the detected parameters, either in private production parameters of the mobile network operators, or in a set of parameters shared and mutually maintained by the mobile network operators.

4. A method for synchronizing operating parameters among mobile network operators, where each operator operates a mobile network according to values of operating parameters privately maintained by the operator; the method comprising:
automatically detecting a new operating parameter or value maintained by a first operator; and
in response to the detecting, using a data network to automatically cause a second mobile operator to update its operating parameters or values to reflect the new or updated local parameter of the first operator.

5. A method according to claim 4, wherein the operating parameters comprise roaming parameters shared among the mobile network operators to handle roaming calls.

6. A method according to claim 5, wherein the data network comprises a publicly accessible non-telephony data network.

7. A method according to claim 5, wherein the data network comprises the Internet.

8. A method for network parameter correction using a set of roaming parameters shared by mobile network operators, the method comprising:
automatically detecting differences between private production parameters of the mobile network operators and corresponding shared parameters, automatically updating the set of shared roaming parameters to reflect the differences, and using the updated set of shared roaming parameters for further difference detection by the mobile network operators.

9. A method according to claim 8, private production parameters of a mobile network operator are initialized based on the set of shared roaming parameters.

10. A method for exchanging parameters between mobile operators over a data network, where each of the operators maintains internal production operating parameters according to which the operators respectively handle mobile calls, the method comprising:
accessing, with a communication unit, the internal production parameters maintained by the operator; and
triggering, with the communication unit, distribution of update messages over the data network to other operators, where the messages reflect changes to the local parameters maintained by the operator.

11. A method according to claim 10, wherein the other operators use the messages to detect errors with their internal production parameters.

12. A method, comprising:
maintaining a central repository of network parameters of network operators and sharing the central repository with the network operators;
maintaining at each network operator a local copy of network parameters;
automatically detecting a discrepancy between a network operator's local copy of network parameters to the network operators corresponding private production network parameters, the detecting comprising comparing the network operator's local copy of network parameters to the corresponding private production network parameters of the network operator; and
at least one of:
automatically updating the central repository of network parameters to reflect the detected discrepancy, and updating the central repository of network parameters to also reflect the detected discrepancy; and
automatically updating a private production network parameter in accordance with the detected discrepancy.

13. A method according to claim 12, further comprising, after updating the central repository, sending update messages to network operators based on the updating of the central repository and updating their local copies of network parameters based on the update messages.

14. A method according to claim 13, further comprising updating private production network parameters of the network operators receiving the update messages, whereby the production parameters of the network operator originating the update and the production parameters of the network operators receiving the update messages become synchronized.

15. An apparatus for synchronizing operating parameters among mobile network operators, where each operator operates a mobile network according to values of operating parameters maintained by the operator; the apparatus comprising:
a device provided with connectivity to the operating parameters and values maintained by a first operator, where the device automatically detects a new operating parameter or value maintained by a first operator and in response uses a data network to automatically cause a second mobile operator to update its operating parameters or values to reflect the new or updated local parameter of the first operator.

16. An apparatus according to claim 15, wherein the data network comprises a publicly accessible non-telephony data network.

17. An apparatus for network parameter correction using a set of roaming parameters shared by network operators, the apparatus comprising:
detection means for automatically detecting differences between private production parameters of the network operators and corresponding shared parameters; and
updating means for automatically updating the set of shared roaming parameters to reflect the differences, and using the updated set of shared roaming parameters for further difference detection by the network operators.

18. An apparatus according to claim 17, further comprising propagating means for propagating updates of the set of shared roaming parameters to production operating parameters of some of the network operators.

19. A computer-readable storage storing information for enabling a computer to perform a process for synchronizing operating parameters among mobile network operators, where each operator operates a mobile network according to values of operating parameters maintained by the operator; the process comprising:
automatically detecting a new operating parameter or value maintained by a first operator; and
in response to the detecting, transmitting a signal or message to a data network, where the signal or message automatically causes a second mobile operator to update its operating parameters or values to reflect the new or updated local parameter of the first operator.
